(19) United States
(12) Patent Application Publication
(10) Pub. No.: US 2024/0311925 A1
(43) Pub. Date: Sep. 19, 2024

(54) RISK DETECTION AND MITIGATION SYSTEMS AND METHODS

(71) Applicant: Allstate Insurance Company, Northbrook, IL (US)

(72) Inventors: Jennifer L. Snyder, Northbrook, IL (US); Trent Bohacz, Northbrook, IL (US); Tai-Yip Kwok, Northbrook, IL (US); Michael Watson, Northbrook, IL (US)

(73) Assignee: Allstate Insurance Company, Northbrook, IL (US)

(21) Appl. No.: 18/605,277

(22) Filed: Mar. 14, 2024

Related U.S. Application Data
(60) Provisional application No. 63/490,273, filed on Mar. 15, 2023.

(51) Int. Cl. G06Q 40/08

(52) U.S. Cl. CPC G06Q 40/08

(57) ABSTRACT

Intelligent risk detection systems and methods include one or more processors, one or more memory components communicatively coupled to the one or more processors, and machine readable instructions that cause the system to determine one or more risk factors with respect to a monitored item based on one or more sensors, determine, via a risk model, a risk score indicative of a risk of a danger event based on the one or more risk factors, detect whether the risk score is above a threshold risk score, generate a risk event detection when the risk score is above the threshold risk score, transmit a risk detection alert based on generation of the risk event detection, activate a risk mitigation activation sensor, and determine whether an updated risk score is below the threshold risk score such that the risk of the danger event is determined to be mitigated.

### CROSS-REFERENCE TO RELATED APPLICATIONS

The present application claims priority to U.S. Provisional Patent Application No. 63/490,273, filed Mar. 15, 2023, and entitled “RISK DETECTION AND MITIGATION SYSTEMS AND METHODS,” the entirety of which is incorporated by reference herein.

### TECHNICAL FIELD

The present specification generally relates to intelligent risk detection systems, and more particularly, to systems and methods for detection and mitigation of a risk event based on an intelligent risk model and sensors.

### BACKGROUND

Risk events can turn into dangerous incidents resulting in loss. For example, a burning candle set near a curtain may cause a house fire, resulting in a partial or total loss of the house. The loss may result in outcomes such as renovation and a claim submitted to an insurance company, for example. A need exists for more efficient risk detection system to detect risk events to reduce such loss.

### SUMMARY

Aspects of the present disclosure relate to intelligent risk detection of danger events. In particular, aspects of the disclosure relate to detecting whether a risk score indicative of a risk of a danger event is above a threshold risk score.

According to the subject matter of the present disclosure, an intelligent risk detection system may include one or more processors, one or more memory components communicatively coupled to the one or more processors, and machine readable instructions stored in the one or more memory components. The machine readable instructions may cause the intelligent risk detection system to perform processes and logic schemes as described herein when executed by the one or more processors.

According to the subject matter of the present disclosure, an intelligent risk detection system may include one or more processors, one or more memory components communicatively coupled to the one or more processors, and machine readable instructions stored in the one or more memory components that cause the intelligent risk detection system to perform at least the following when executed by the one or more processors: determine one or more risk factors with respect to a monitored item based on one or more sensors, determine, via a risk model, a risk score indicative of a risk of a danger event based on the one or more risk factors, detect whether the risk score indicative of the risk of the danger event is above a threshold risk score, and generate a risk event detection when the risk score indicative of the risk of the danger event is above the threshold risk score. The machine readable instructions may further cause the intelligent risk detection system to perform at least the following when executed by the one or more processors: transmit a risk detection alert based on generation of the risk event detection, activate a risk mitigation activation sensor based on the risk detection alert, and determine, via the risk model and based on the one or more risk factors, whether an updated risk score indicative of the risk of the danger event is below the threshold risk score such that the risk of the danger event is determined to be mitigated.

According to another embodiment of the present disclosure, an intelligent risk detection system may include one or more processors, one or more memory components communicatively coupled to the one or more processors, and machine readable instructions stored in the one or more memory components that cause the intelligent risk detection system to perform at least the following when executed by the one or more processors: determine one or more risk factors with respect to a monitored item based on one or more sensors. The one or more sensors include one or more risk detection sensors configured to monitor the monitored item, one or more user detection sensors configured to detect a location of the user, or combinations thereof. The one or more risk factors based on the one or more sensors include a monitored activity associated with the monitored item above a monitored activity threshold, a proximity of a user with respect to the monitored item, or combinations thereof. The machine readable instructions may further cause the intelligent risk detection system to perform at least the following when executed by the one or more processors: determine, via a risk model, a risk score indicative of a risk of a danger event based on the one or more risk factors, detect whether the risk score indicative of the risk of the danger event is above a threshold risk score, generate a risk event detection when the risk score indicative of the risk of the danger event is above the threshold risk score, transmit a risk detection alert based on generation of the risk event detection, activate a risk mitigation activation sensor based on the risk detection alert, and determine, via the risk model and based on the one or more risk factors, whether an updated risk score indicative of the risk of the danger event is below the threshold risk score such that the risk of the danger event is determined to be mitigated.

According to yet another embodiment of the present disclosure, a method for intelligent risk detection may include determining one or more risk factors with respect to a monitored item based on one or more sensors, determining, via a risk model, a risk score indicative of a risk of a danger event based on the one or more risk factors, detecting whether the risk score indicative of the risk of the danger event is above a threshold risk score, and generating a risk event detection when the risk score indicative of the risk of the danger event is above the threshold risk score. The method may further include transmitting a risk detection alert based on generation of the risk event detection, activating a risk mitigation activation sensor based on the risk detection alert, and determining, via the risk model and based on the one or more risk factors, whether an updated risk score indicative of the risk of the danger event is below the threshold risk score such that the risk of the danger event is determined to be mitigated.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals in which:

FIG. 1 schematically depicts an intelligent risk detection model architecture, according to one or more embodiments shown and described herein;

FIG. 2 schematically depicts an illustrative flowchart of a process for the intelligent risk detection model architecture of FIG. 1, according to one or more embodiments shown and described herein; and

FIG. 3 schematically depicts a system for use with the intelligent risk detection model architecture of FIG. 1 and for implementing computer and software based processes as set forth in FIG. 2, according to one or more embodiments shown and described herein.

### DETAILED DESCRIPTION

In embodiments described herein, intelligent risk detection systems and methods detect one or more risk events based on an intelligent risk model and input data, such as from one or more sensors, and undertake operations to mitigate such detected risk events. Embodiments of the present disclosure are thus directed to risk detection systems and computer-implemented methods of risk detection and mitigation, as will now be described in more detail herein with reference to the drawings and where like numbers refer to like structures.

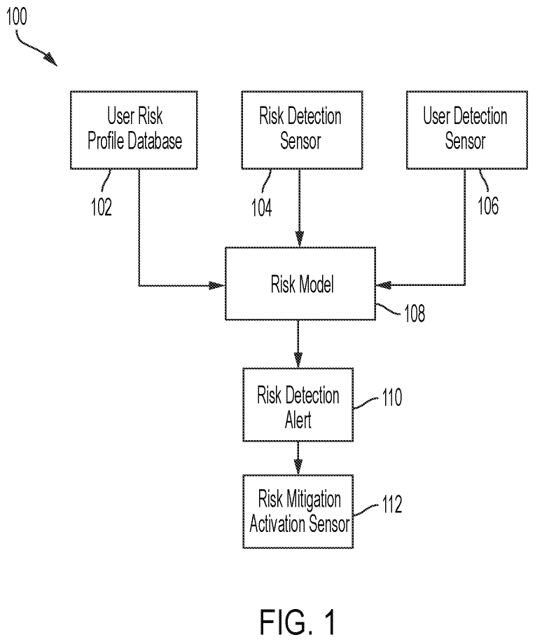

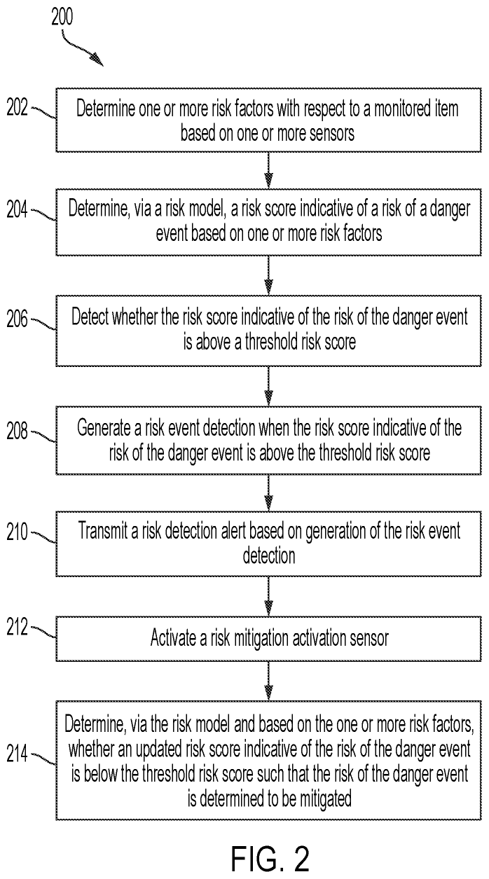

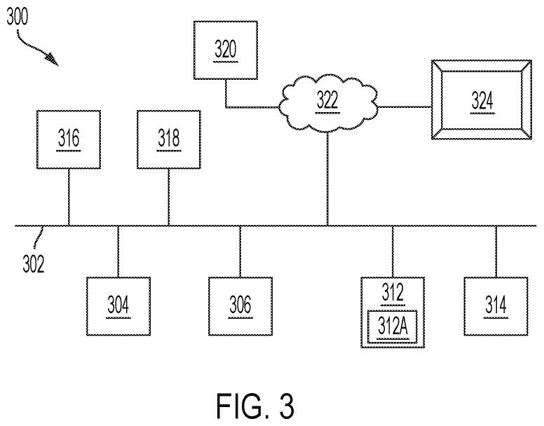

Referring now to FIG. 1, an intelligent risk detection model architecture 100 of an intelligent risk detection system 300 (described in greater detail further below with reference to FIG. 3) may include a user risk profile database 102, at least a risk detection sensor 104, at least a user detection sensor 106, a risk model 108, a risk detection alert 110, and a risk mitigation activation sensor 112. The intelligent risk detection system 300 may include one or more processors 304, one or more memory components 306 communicatively coupled to the one or more processors 304, and machine readable instructions stored in the one or more memory components 306 that cause the intelligent risk detection system to perform one or more processes and controls as described herein (such as process 200 set forth in FIG. 2) when executed by the one or more processors 304. By way of example and not as a limitation, and as will be described in greater detail further below, using components of the intelligent risk detection model architecture 100, and with respect to the process 200, one or more risk factors may be determined with respect to a monitored item based on one or more sensors (e.g., at least the risk detection sensor 104, at least the user detection sensor 106, or combinations thereof; see block 202 of FIG. 2). Via a risk model 108, a risk score indicative of a risk of a danger event may be determined based on the one or more risk factors (see block 204 of FIG. 2). A risk event detection may be generated when the risk score indicative of the risk of the danger event is above a threshold risk score (see blocks 206-208 of FIG. 2), and the risk detection alert 110 transmitted based on the risk event detection generation (see block 210 of FIG. 2). The risk mitigation activation sensor 112 may be activated based on the risk detection alert 110 (see block 212 of FIG. 2). Via the risk model and based on the one or more risk factors, an updated risk score may be determined. The updated risk score may be indicative of the risk of the danger event being below the threshold risk score such that the risk of the danger event is determined to be mitigated (see block 214 of FIG. 2). The one or more risk factors may be further based on a risk profile of a user stored in the user risk profile database 102 communicatively coupled to the intelligent risk detection system 300.

Referring again to FIG. 1, the user risk profile database 102 may be a database including information about a risk profile of a user. As non-limiting examples, the risk profile of the user monitored by the intelligent risk detection model architecture 100 that is stored in the user risk profile database 102 may include one or more risk scores for risk factors associated with previous amount of losses (such as a number of times the user has filed a loss claim and the amount of funds receive to repair or replace the loss from, for example, an insurance provider), assets with associated risk information (such as age of roofing on a property owned by the user, behavioral risk tendencies of the user such as time periods the user has left monitored property premises while electronic items are left unattended), and the like. In embodiments, when a user is determined to leave a home often when an item being monitored (e.g., a monitored item) is on and thus often leave the monitored item unintended, a risk score associated with the risk factor of the risk profile for the user may be heightened to indicate a higher user risk. Additionally or alternatively, hazards detected by the risk model 108 may act as risk factors to indicate a higher user risk. Such hazards may be, for example, children or pets in proximity to the monitored item when the user or an adult individual is not in near proximity to the monitored item. Other hazards may be a location of the monitored item, such as a portable heater being place on a floor and on carpet and left unmonitored when left on.

In embodiments, when the risk model 108 determines a user is engaging is less risk activities over time than that associated with the risk events detected by the risk model 108, the risk model 108 may determine that the user should be rewarded with an improved wellness score, which may result in a monetary award or discount of, for example, an insurance premium related to the monitored item. However, when the risk model 108 determines that the user is engaging is higher risk activities over time based on the risk events detected by the risk model 108, the risk model 108 may determine that the user should be penalized, such as through a reduction of a wellness score, which may result in a penalization of a previously applied discount or an increase in an insurance premium related to the monitored item or decrease in the discount.

In embodiments, the one or more sensors may include the one or more risk detection sensors 104 configured to monitor the monitored item, one or more user detection sensors 106 configured to detect a location of the user, or combinations thereof. Specifically, the risk detection sensor 104, which may include one or more risk detection sensors 104, may be configured to monitor items, such as appliances, via audiovisual signals and/or thermal to detect risk associated with operation of such items. The one or more risk detection sensors 104 may be configured to monitor the monitored item via an audiovisual signal, a sound signal, or combinations thereof. By way of example, and not as a limitation, the risk detection sensor 104 may be a camera such as a smart camera configured to monitor an item for cooking, such as a cooktop stove or an oven, to aid in preventing fires (such as when the monitored items are being used for cooking and are left unattended). In embodiments, the smart camera may be installed in a kitchen, either fixedly or removably, and pointed toward the monitored item. The smart camera may be pointed to the monitored item automatically via sensors and build in mechanical gearing. In embodiments, the smart camera may include a 360 degree lens that monitors a room at large in which room the monitored item is placed. The smart camera may be configured to zoom in and zoom out on features within a field of view automatically or manually. The risk detection sensor 104 may be communicatively coupled to an application, such as an application of a smart mobile device such as a smart phone or smart pad. The intelligent risk detection model architecture 100 may utilize edge computing in embodiments, such as by using the application of the smart mobile device locally. In other embodiments, the intelligent risk detection model architecture 100 may be connected to a broader network such as the cloud beyond local edge computing. In embodiments, the risk detection sensor 104 may be a thermal sensor such as an infrared detection sensor configured to monitor heat as temperature of a monitored item. Additionally or alternatively, sounds associated with the monitored items may be detected by the risk detection sensor 104, such as sounds of a fire if a flame is being used for cooking or sounds a stovetop or oven produces, to further assist in identifying a monitored item and when the monitored item is being used. In embodiments, the monitored sounds may include alarm sounds, such as a fire alarm sound and/or carbon monoxide alarm sound.

The one or more user detections sensors 106 may be configured to detect the location of the user in a room with respect to a distance of the item being monitored via location sensing of the user, audiovisual sensing of the user, sound sensing of the user, or combinations thereof. The user detection sensor 106, which may include one or more user detection sensors 106, may be a location sensor on the smart mobile device of the user such that the smart mobile device provides location data of the user. In embodiments, the smart mobile device may be a smart watch or other smart wearable or usable component and may include smart location tracking features. Additionally or alternatively, the user detection sensor 106 may be a sensor configured to monitor a room and detect whether one or more individuals, which may include the user, is in a room, such as in a kitchen in which the user has been using an item for cooking. The user detection sensor 106 may include audiovisual sensing, location sensing, and/or similar sensing to detect whether a user is in a near proximity to the monitored item by the risk detection sensor 104. Additionally or alternatively, sounds associated with the monitored items may be detected by the user detection sensor 106, such as sounds of the user and/or other individuals in a near proximity of the monitored item. As such, the one or more risk factors based on the one or more sensors may include (i) using at least the risk detection sensor 104), a monitored activity associated with the monitored item above a monitored activity threshold (such as sensing parameters associated with cooking via a container on a stovetop to set as risk factors when the sensed parameters are above a threshold, e.g., heat over a certain temperature is sensed for a long enough period to determine a stovetop has been turned on), (ii) using at least the user detection sensor 106, a proximity of the user with respect to the monitored item, or combinations thereof.

The risk model 108 is an artificial intelligence model that may be trained based on an artificial intelligence training algorithm. The artificial intelligence model may include artificial intelligence components selected from the group consisting of an artificial intelligence engine, Bayesian inference engine, and a decision-making engine, and may have an adaptive learning engine further comprising a deep neural network learning engine. The artificial intelligence training algorithm may train the risk model 108 based on training datasets to detect risk of monitored items. The artificial intelligence training algorithm may train the risk model 108 based on training datasets to detect risk of one or more monitored items, the training datasets comprising examples of the one or monitored items, historical loss data associated with a plurality of users, historical loss data associated with the one or more monitored items, risk data associated with the one or more monitored items, or combinations thereof. The training datasets may include examples of the monitored items and historical loss data and associated risk data associated with monitored items. Thus, the trained risk model 108 is configured to receive inputs from, for example, the user risk profile database 102, the risk detection sensor 104, and/or the user detection sensor 106 to determine whether a risk of a danger event associated with an item being monitored is at a level above a threshold to generate a risk event and associated risk detection alert 110. By way of example, and not as a limitation, the item being monitored may be a container placed on a heated stovetop, which container holds cookable items, to cook the items.

In embodiments, levels of risks may be associated with the monitored item, such that the risk model 108 (based on the one or more risk factors) may detect whether the risk score is indicative of a normal level of risk associated with the monitored item below a normal threshold risk score, such that the normal threshold risk score is below the threshold risk score. The risk model may also detect a medium level of risk associated with the monitored item above the normal threshold risk score and below a medium threshold risk score, such that the medium threshold risk score is greater than the normal threshold risk score and one of below or above the threshold risk score. Moreover, the risk model may detect a high level of risk associated with the monitored item above the medium threshold risk score and below a high threshold risk score, such that the high threshold risk score is greater than the medium threshold risk score and above the threshold risk score.

By way of example, and not as a limitation, the risk model may detect that the risk score is indicative of the normal level of risk when a detected heat of the monitored item is determined to be within a first predetermined heat range associated with a normal range for cooking, within a boundary of the monitored item within a suitable predefined tolerance, or combinations thereof. The risk model may also detect that the risk score is indicative of the medium level of risk when the detected heat of the monitored item is determined to be within a second predetermined heat range higher than the first predetermined heat range, outside the boundary of the monitored item within a first boundary range outside of the suitable predefined tolerance, or combinations thereof. Moreover, the risk model may detect that the risk score is indicative of the high level of risk when the detected heat of the monitored item is determined to be within a third predetermined heat range higher than the second predetermined heat range, outside the boundary of the monitored item within a second boundary range outside of the suitable predefined tolerance and greater than the first boundary range, or combinations thereof. In embodiments, the risk mitigation activation sensor 112 may be activated to automatically transmit the risk detection alert when the one or more sensors sense the detected heat of the monitored item is outside of the boundary of the monitored item within the first boundary range or the second boundary range. The risk detection alert may be transmitted to a fire department system, a smart mobile device of a first user in a first building in which the monitored item is contained, a smart mobile device of a second user in another building in a predefined proximity to the first building, or combinations thereof.

By way of example, and not as a limitation, the monitored item may be a container on a stovetop, which container holds cookable items, to cook the monitored items. The risk model 108 is configured to monitor the container, such as via an infrared detection sensor to monitor temperature as the risk detection sensor 104, and determine levels of risk associated with the container. For example, at a normal level of risk, the risk model 108 may determine the container is within a first predetermined heat range associated with a normal range of heat for cooking and/or that the detected heat is within the boundary of the container within a suitable predefined tolerance. At a medium level of risk, the risk model 108 may determine the container is within a second predetermined heat range higher than the first predetermined heat range associated with a higher than normal range of heat for cooking and/or that the detected heat is outside the boundary of the container within a first boundary range outside of the suitable predefined tolerance. At a high level of risk, the risk model 108 may determine the container is within a third predetermined heat range higher than the second predetermined heat range associated with a much higher than normal range of heat for cooking and/or that the detected heat is outside the boundary of the container within a second boundary range outside of the suitable predefined tolerance. The second boundary range is greater than the first boundary range. Further, an associated boundary range (e.g., the first or second boundary range) may be determined for a predetermined amount of time prior to a level being reached.

In embodiments, the monitored item may be a container on a stovetop, a portable space heater, an oven, a candle, a water heater, a dryer vent, fluid containing item to prevent fluid leaks, gas containing item monitored to prevent gas leaks, or combinations thereof. The monitored item may be monitored to prevent fires and may be, for example, a heating device other than a stovetop as described above such as a portable space heater, an oven, candles, a water heater, dryer vents for a dryer in operation, and/or other suitable heat based appliances. Additionally or alternatively, the monitored item may be a fluid containing item monitored to prevent fluid leaks, such as a faucet or a heat pump or dishwasher or water pan under a water heater or the water heater or water pipes or sump pump or the like. The risk detection sensor 104 may be used to detect the leakage, such as a camera or sensor as described herein pointed at the water pan to detect leaker of the water heater. The fluid may be water or other liquids. In embodiments, the monitored item may be a gas containing item being monitored to prevent gas leaks, such as a carbon monoxide monitor.

In embodiments, the risk detection alert 110 may include educational material related to mitigation of the risk of the danger event when the one or more sensors sense the detected heat of the monitored item is outside of the boundary of the monitored item within the first boundary range or the second boundary range is indicative of a fire spread beyond container. The risk detection alert 110 may include educational material including instructions, coaching, or combinations thereof related to mitigation of the risk event. The risk detection alert 110 may be an audiovisual alert such as a text, notification sound, a color coded notification, a flashing image notification, or the like sent to, for example, the smart mobile device of the user via the application communicatively coupled to the risk model 108. The risk detection alert 110 may also send the audiovisual alert to the user when the user detection sensor 106 does not sense the user within a near, predefined threshold proximity of the monitored item. In embodiments, the risk detection alert 110 may be sent to a person or entity other than the user, such an external entity device of (i) a fire department, (ii) another predefined user such as a neighbor, and/or (iii) other designated individuals or entities, or (iv) combinations thereof. As a non-limiting example, the risk detection alert 110 may be sent automatically, such as to a local fire department and/or neighbor, when the risk detection sensor 104 senses the detected heat for the monitored item, such as the container on the heated stovetop, is outside the boundary of the container within the first boundary range or the second boundary range outside of the suitable predefined tolerance, indicative that such that a fire has spread beyond the container. In embodiments, the risk detection alert 110 may include educational material related to the risk event and/or mitigation of the risk event, such as how to put out a grease fire when the risk event is identified as a grease fire. Additionally or alternatively, the educational material may include an audible real-time announcement via, for example, a smart speaker, such as to announce a grease fire is detected with instructions to cover the grease fire with a lid and not attempt to put the grease fire out with water.

In embodiments, such education material may involve further coaching for the user, such as the risk event detected causing the risk detection alert 110 to prompt the user to take an immediate action, such as putting out the grease fire in the above example. Additionally or alternatively, the coaching may inform the user of habits to mitigation risk, such as advising the user not to turn on an appliance at a time at which the user is commonly known to leave the premises (such as certain times the user may leave to, for example, walk a pet).

The risk mitigation activation sensor 112 is configured to be activated to mitigate the risk event as detected. In embodiments, the risk mitigation activation sensor 112 may be configured to transmit a command to the application associated with the smart mobile device of the user to automatically unlock all doors associated with a building within which the monitored item when the risk detection alert 110 is sent. In embodiments, the building may be a house or home, an apartment, a townhome, a condominium, a residential property, a commercial property, an office, or other suitable building structure. Thus, for a home with a smart lock on the doors, which smart lock is compatible with the application on the smart mobile device of the user, the application can trigger an unlocking of the smart lock such that all doors are unlocked to allow occupants to escape a risk event such as a fire. Additionally or alternatively, the risk mitigation activation sensor 112 may be activated to disable an electronic component, which may include a connect to a main circuit breaker, or other component associated with operations with respect to the monitored item. In embodiments, a water valve may be automatically shut-off when a water leak is detected and/or a gas valve may be automatically shut-off when a gas leak is detected. Further, the electronic component may be the stovetop such that a control coupled to the heating components of the stovetop may be instructed to turn the stovetop off or reduce heat of the stovetop. In aspects, a smart feature may be activated such as a smart garage door that may be instructed to close if detected to be open when the user is not detected within the home by the user detection sensor 106 and/or by a communication by a coupled home security system that occupants have left the home. The risk mitigation activation sensor 112 may further be activated to enable smart features of coupled components, such as turning on smart lighting if a fire is detected to light a path for occupants to escape and/or turning on a smart internal sprinkler system to attempt to put out the fire or turning on another type of smart fire extinguishing system to contain a fire detected with respect to the monitored item. In embodiments, the risk mitigation activation sensor 112 may be activated automatically upon determination of the risk event or after a predetermined period of time.

Referring to FIG. 2, a process 200 is shown which the risk model 108 may be implemented to intelligently detect risk and mitigate the detected risk as described herein. In block 202, one or more risk factors are determined with respect to a monitored item based on the one or more sensors described herein, such as the risk detection sensor 104 and/or the user detection sensor 106. In embodiments, the risk factors may additionally be determined by the user risk profile database 102 as described herein. The risk factors may additionally or alternatively include external data such as weather data that may heighten a sensitivity of notification regarding a risk event, such as in instances of severe weather, lowering a threshold of the risk score to detect the risk event.

In block 204, via the risk model 108, a risk score is determined indicative of a risk of a danger event based on one or more risk factors. In block 206, a determination is made of whether the risk score indicative of the risk of the danger event is above the threshold risk score. In block 208, a risk detection event is generated when the risk score indicative of the risk of the danger event is above the threshold risk score.

The risk model 108 may include an artificial intelligence model trained based on an artificial intelligence training algorithm. The artificial intelligence model can be configured to apply machine learning to continually improve outputs with improved calibration confidence scores associated with outputs (e.g., a predicted risk event of an item being monitored and/or identified type of risk event). In embodiments, as set forth herein, the risk factors may include external data such as weather data than may heighten a sensitivity of notification regarding a risk event, such as in instances of severe weather, lowering a threshold of the risk score to detect the risk event. Thus, the one or more risk factors may also include external data including an indication of weather data in a proximity to the monitored item. The indication of weather data at a first level may be configured to decrease the threshold risk score, the indication of weather data at a second level above the first level may be configured to maintain the threshold risk score, and the indication of weather data at a third level above the second level may be configured to increase the threshold risk score.

In embodiments, the intelligent risk detection system 300 may include pricing models that are tailored based on risk scores and/or the risk factors. The pricing model may be configured to at least one of set or dynamically adjust an insurance premium pricing for a user associated with the monitored item based on a plurality of historical risk scores for a plurality of users over a period of time, a plurality of risk factors for the plurality of users of the period of time, or combinations thereof. As non-limiting examples, a risk score for a user that is increased over a period of time may result in an increase in a price for a feature, such as an insurance premium for the user. Moreover, the pricing model may be configured to adjust an insurance premium pricing for the user based on the risk score for the user over a period of time. The pricing model may configured to lower the insurance premium pricing when the risk score decreases over the period of time to below a first risk score level, maintain the insurance premium pricing when the risk score stays over the period of time at a second risk score level above the first risk score level, and raise the insurance premium pricing when the risk score increases over the period of time to a third risk score level above the second risk score level, such that the third risk score level is above the threshold risk score.

Historical tracked risk scores and risk factors across a plurality of users over time may also be used to set and dynamically adjust pricing in pricing models, which may set insurance premium pricing and/or insurance premium discounts. Insurance premium pricing may be increased and/or insurance premium discounts may be decreased when the risk score for a user increases over time. Alternatively, insurance premium pricing may be decreased and/or insurance premium discounts may be increased when the risk score for a user decreases over time. The risk score data may be collected and/or risk score adjusted over intervals of time, such as monthly, quarterly or annually. In aspects, single risk events and/or aggregated risk events may contribute to risk score determinations. Pricing models may be updated after risk scores are updated.

Risk scores may be updated in real-time and have a gamification applied to encourage reduced risk behaviors to keep risk scores low. A low risk score within a low risk score range for a period of time may add points to a user's profile to result in awards, such as an increase in a wellness score used for pricing discounts or other user benefits. The following risk factors may be considered in determining the risk score of a user and whether or not to increase or decrease the risk score: 1) a single event detection; 2) aggregated event detections; 3) event detection patterns; 4) an absence of risky events; and 5) user response to risk mitigation alerts/coaching efforts communicated in response to the detected risk events. For example, when a risk event is detected by the intelligent risk detection system 300 and the user is alerted of a risk mitigation action, and an increase in the risk score for the user may be avoided or abated when the user (e.g., potentially the homeowner) acknowledges the alert and/or acts on the alert. The risk detection alert may be transmitted to a user and the risk score associated with the user is updated in real-time, such that an increase to the risk score is avoided or abated when the user at least one of acknowledges the risk detection alert or follows instructions transmitted by the risk mitigation activation sensor.

In embodiments, thus, the intelligent risk detection system 300 may adjust the risk score associated with the user based on the one or more risk factors including one or more risk factor points based on a single detection event, a series of aggregated detection events, one or more event detection patterns, an absence of risky events, user response to the risk detection alert, or combinations thereof. The risk score may be lowered in response to the one or more risk factor points being below a first risk factor threshold, while the risk score may be maintained in response to the one or more risk factor points being below a second risk factor threshold above the first risk factor threshold. Moreover, the risk score may be increased in response to the one or more risk factor points being above a third risk factor threshold above the second risk factor threshold.

In block 210, the risk detection alert 110 is transmitted based on generation of the risk event detection (e.g., in block 208). In embodiments, the alert may be used to aid in pricing insurance policies and the like related to the monitored item, such as increasing a premium based on an increased risk by the user of the monitored item as identified by the risk model 108.

In block 212, one or more sensors are activated based on the risk detection alert 110 to mitigate risk of the risk event. In embodiments, the one or more sensors that are activated include the one or more risk mitigation activation sensors 112 as described herein. As a non-limiting example, the activation may include a sending of commands to turn off heat of an item being monitored, reduce heat of the item being monitored, open door locks of a building in which the item being monitored is disposed, and the like.

Thus, in block 212, the risk mitigation activation sensor 112 may be activated. In embodiments, the risk mitigation activation sensor 112 may be activated when the risk of the danger event is above the threshold risk score and after a predetermined period of time has passed. The risk mitigation activation sensor transmits a command to the application associated with a smart mobile device of the user. As a non-limiting example, the activation may include a sending of commands to automatically unlock doors associated with a building associated with the user and communicatively coupled to the smart mobile device, disable an electronic component communicatively coupled to the smart mobile device, shut off a water valve or a gas valve communicatively coupled to the smart mobile device when a respective water or gas leak is detected, close a garage door communicatively coupled to the smart mobile device when the user is not detected within a boundary of the building including the garage door, activate lighting of the building and communicatively coupled to the smart mobile device to illuminate a path for the user to escape the building, activate a sprinkler or fire extinguishing system communicatively coupled to the smart mobile device to contain or put out a fire, or the like.

In block 214, via the risk model 108 and based on the one or more risk factors, a determination is made whether an updated risk score indicative of the risk of the danger event is below the threshold risk score such that the risk of the danger event is determined to be mitigated. As a non-limiting example and as described above, input from the risk detection sensor 104 may be used by the risk model 108 to determine that the heat associated with the container on the heated stovetop is at the normal level of risk such that the container is within the first predetermined heat range associated with the normal range of heat for cooking and/or that the detected heat is within the boundary of the container within the suitable predefined tolerance. Additionally or alternatively, input from the user detection sensor 106 may be used by the risk model 108 to determine that the user has returned and/or is in near proximity to the monitored item. The risk model 108 may include a plurality of parameters and boundary ranges to set one or more levels of risk and associated mitigation measures as described herein.

Referring to FIG. 3, an embodiment of an intelligent risk detection system 300 as described herein includes a communication path 302, one or more processors 304, a memory component 306, an artificial intelligence module 312, a machine learning sub-module 312A of the artificial intelligence module 312, a storage or database 314 (e.g., which may include the user risk profile database 102 of FIG. 1), a sensor communication module 316, a network interface hardware 318, a network 322, a server 320, and a device 324, such as a computing device. The various components of the intelligent risk detection system 300 and the interaction thereof will be described in detail below.

While only one server 320 and one device 324 is illustrated, the intelligent risk detection system 300 can comprise multiple servers containing one or more applications and computing devices. In some embodiments, the intelligent risk detection system 300 is implemented using a wide area network (WAN) or network 322, such as an intranet or the internet. The device 324 may include digital systems and other devices permitting connection to and navigation of the network 322. It is contemplated and within the scope of this disclosure that the device 324 may be a personal computer, a laptop device, a smart mobile device such as a smart phone or smart pad or smart wearable component that may include smart watches and/or smart glasses, or the like. Other intelligent risk detection system 300 variations allowing for communication between various geographically diverse components are possible. The lines depicted in FIG. 3 indicate communication rather than physical connections between the various components.

The intelligent risk detection system 300 comprises the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the intelligent risk detection system 300. As used herein, the term “communicatively coupled” means that coupled components are capable of exchanging data signals with one another such as, for example, electrical signals via conductive medium, electromagnetic signals via air, optical signals via optical waveguides, and the like.

The intelligent risk detection system 300 of FIG. 3 also comprises the one or more processors 304. Each processor 304 can be any device capable of executing machine readable instructions. Accordingly, each processor 304 may be a controller, an integrated circuit, a microchip, a computer, or any other computing device. Each processor 304 is communicatively coupled to the other components of the intelligent risk detection system 300 by the communication path 302. Accordingly, the communication path 302 may communicatively couple any number of processors 304 with one another, and allow the modules coupled to the communication path 302 to operate in a distributed computing environment. Specifically, each of the modules can operate as a node that may send and/or receive data.

The illustrated intelligent risk detection system 300 further comprises the memory component 306 which is coupled to the communication path 302 and communicatively coupled to a processor 304 of the one or more processors 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor 304, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 3, as noted above, the intelligent risk detection system 300 comprises a display, such as a graphical user interface (GUI), on a screen of the device 324 for providing visual output such as, for example, information, graphical reports, messages, or a combination thereof. The display on the screen of the device 324 is coupled to the communication path 302 and communicatively coupled to the processor 304. Accordingly, the communication path 302 communicatively couples the display to other modules of the intelligent risk detection system 300. The display can comprise any medium capable of transmitting an optical output such as, for example, a cathode ray tube, light emitting diodes, a liquid crystal display, a plasma display, or the like. Additionally, it is noted that the display or the device 324 can comprise at least one of the processor 304 and the memory component 306. While the intelligent risk detection system 300 is illustrated as a single, integrated system in FIG. 3, in other embodiments, the systems can be independent systems.

The intelligent risk detection system 300 comprises the artificial intelligence module 312 configured to train and/or implement the risk model for the intelligent risk detection system 300 as described herein. The machine learning sub-module 312A of the artificial intelligence module 312 is configured to provide feedback to improve risk model performance and implement a technical effect of improved model accuracy. The sensor communication module 316 is configured to communicate with one or more sensors as described herein to interact with the risk model based on the processes described herein.

The artificial intelligence module 312, the machine learning sub-module 312A, and the sensor communication module 316 are coupled to the communication path 302 and communicatively coupled to the processor 304. As will be described in further detail below, the processor 304 may process the input signals received from the system modules and/or extract information from such signals.

Data stored and manipulated in the intelligent risk detection system 300 as described herein is utilized by the artificial intelligence module 312, which is able to leverage a cloud computing-based network configuration such as the cloud to apply machine learning and artificial intelligence. The machine learning application may create models that can be applied by the intelligent risk detection system 300 to become more efficient and intelligent in execution. In embodiments, the intelligent risk detection system 300 may utilize one or more artificial neural network (ANN) models as understood to those skilled in the art or as yet-to-be-developed to generate communications and alerts as described in embodiments herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from audio, images, clustering algorithms, or combinations thereof.

As an example and not a limitation, a machine learning module of the ANN may include artificial intelligence components selected from the group consisting of an artificial intelligence engine, Bayesian inference engine, and a decision-making engine, and may have an adaptive learning engine further comprising a deep neural network learning engine. Data stored and manipulated in the intelligent risk detection system 300 as described herein is utilized by the machine learning module, which in embodiments able to leverage a cloud computing-based network configuration such as the cloud to apply machine learning and artificial intelligence or may be able to rely on an internal architecture to apply machine learning and artificial intelligence as described herein. This machine learning application may create models that can be applied by the intelligent machine learning to make it more efficient and intelligent in execution.

The intelligent risk detection system 300 further includes the network interface hardware 318 for communicatively coupling the intelligent risk detection system 300 with a computer network such as network 322. The network interface hardware 318 is coupled to the communication path 302 such that the communication path 302 communicatively couples the network interface hardware 318 to other modules of the intelligent risk detection system 300. The network interface hardware 318 can be any device capable of transmitting and/or receiving data via a wireless network. Accordingly, the network interface hardware 318 can comprise a communication transceiver for sending and/or receiving data according to any wireless communication standard. For example, the network interface hardware 318 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 3, data from various applications running on device 324 can be provided from the device 324 to the intelligent risk detection system 300 via the network interface hardware 318. The device 324 can be any device having hardware (e.g., chipsets, processors, memory, etc.) for communicatively coupling with the network interface hardware 318 and a network 322. Specifically, the device 324 can comprise an input device having an antenna for communicating over one or more of the wireless computer networks described above.

The network 322 can comprise any wired and/or wireless network such as, for example, wide area networks, metropolitan area networks, the internet, an intranet, satellite networks, or the like. Accordingly, the network 322 can be utilized as a wireless access point by the device 324 to access one or more servers (e.g., a server 320). The server 320 and any additional servers generally comprise processors, memory, and chipset for delivering resources via the network 322. Resources can include providing, for example, processing, storage, software, and information from the server 320 to the intelligent risk detection system 300 via the network 322. Additionally, it is noted that the server 320 and any additional servers can share resources with one another over the network 322 such as, for example, via the wired portion of the network, the wireless portion of the network, or combinations thereof.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### Aspects Listing:

Aspect 1. An intelligent risk detection system, the intelligent risk detection system may include: one or more processors, one or more memory components communicatively coupled to the one or more processors, and machine readable instructions stored in the one or more memory components that cause the intelligent risk detection system to perform at least the following when executed by the one or more processors: determine one or more risk factors with respect to a monitored item based on one or more sensors, determine, via a risk model, a risk score indicative of a risk of a danger event based on the one or more risk factors, detect whether the risk score indicative of the risk of the danger event is above a threshold risk score, and generate a risk event detection when the risk score indicative of the risk of the danger event is above the threshold risk score. The machine readable instructions may further cause the intelligent risk detection system to perform at least the following when executed by the one or more processors: transmit a risk detection alert based on generation of the risk event detection, activate a risk mitigation activation sensor based on the risk detection alert, and determine, via the risk model and based on the one or more risk factors, whether an updated risk score indicative of the risk of the danger event is below the threshold risk score such that the risk of the danger event is determined to be mitigated.
Aspect 2. The intelligent risk detection system of Aspect 1, wherein the one or more sensors include one or more risk detection sensors configured to monitor the monitored item, one or more user detection sensors configured to detect a location of the user, or combinations thereof.
Aspect 3. The intelligent risk detection system of any of Aspect 1 to Aspect 2, wherein the one or more risk detection sensors are configured to monitor the monitored item via an audiovisual signal, a thermal signal, a sound signal, or combinations thereof, wherein the one or more user detections sensors are configured to detect the location of the user in a room with respect to a distance of the item being monitored via location sensing of the user, audiovisual sensing of the user, sound sensing of the user, or combinations thereof.
Aspect 4. The intelligent risk detection system of any of Aspect 1 to Aspect 3, wherein the machine readable instructions further cause the intelligent risk detection system to perform at least the following when executed by the one or more processors: detect, via the risk model and based on the one or more risk factors, whether the risk score is indicative of: a normal level of risk associated with the monitored item below a normal threshold risk score, wherein the normal threshold risk score is below the threshold risk score, a medium level of risk associated with the monitored item above the normal threshold risk score and below a medium threshold risk score, wherein the medium threshold risk score is greater than the normal threshold risk score and one of below or above the threshold risk score, or a high level of risk associated with the monitored item above the medium threshold risk score and below a high threshold risk score, wherein the high threshold risk score is greater than the medium threshold risk score and above the threshold risk score.
Aspect 5. The intelligent risk detection system of Aspect 4, wherein the machine readable instructions further cause the intelligent risk detection system to perform at least the following when executed by the one or more processors: detect, via the risk model, the risk score is indicative of the normal level of risk when a detected heat of the monitored item is determined to be within a first predetermined heat range associated with a normal range for cooking, within a boundary of the monitored item within a suitable predefined tolerance, or combinations thereof, detect, via the risk model, the risk score is indicative of the medium level of risk when the detected heat of the monitored item is determined to be within a second predetermined heat range higher than the first predetermined heat range, outside the boundary of the monitored item within a first boundary range outside of the suitable predefined tolerance, or combinations thereof, and detect, via the risk model, the risk score is indicative of the high level of risk when the detected heat of the monitored item is determined to be within a third predetermined heat range higher than the second predetermined heat range, outside the boundary of the monitored item within a second boundary range outside of the suitable predefined tolerance and greater than the first boundary range, or combinations thereof.
Aspect 6. The intelligent risk detection system of Aspect 5, wherein the machine readable instructions further cause the intelligent risk detection system to perform at least the following when executed by the one or more processors: activate the risk mitigation activation sensor to automatically transmit the risk detection alert when the one or more sensors sense the detected heat of the monitored item is outside of the boundary of the monitored item within the first boundary range or the second boundary range.
Aspect 7. The intelligent risk detection system of Aspect 6, wherein the risk detection alert is transmitted to a fire department system, a smart mobile device of a first user in a first building in which the monitored item is contained, a smart mobile device of a second user in another building in a predefined proximity to the first building, or combinations thereof.
Aspect 8. The intelligent risk detection system of Aspect 6 or Aspect 7, wherein the monitored item includes a container on a stovetop, the risk detection alert when the one or more sensors sense the detected heat of the monitored item is outside of the boundary of the monitored item within the first boundary range or the second boundary range is indicative of a fire spread beyond container, and the risk detection alert includes educational material related to mitigation of the risk of the danger event.
Aspect 9. The intelligent risk detection system of any of Aspect 1 to Aspect 8, wherein the monitored item includes a container on a stovetop, a portable space heater, an oven, a candle, a water heater, a dryer vent, fluid containing item to prevent fluid leaks, gas containing item monitored to prevent gas leaks, or combinations thereof.
Aspect 10. The intelligent risk detection system of any of Aspect 1 to Aspect 9, wherein the risk detection alert includes educational material including instructions, coaching, or combinations thereof related to mitigation of the risk event.
Aspect 11. The intelligent risk detection system of any of Aspect 1 to Aspect 10, wherein the machine readable instructions further cause the intelligent risk detection system to perform at least the following when executed by the one or more processors: activate the risk mitigation activation sensor when the risk of the danger event is above the threshold risk score and after a predetermined period of time, wherein the risk mitigation activation sensor transmits a command to an application associated with a smart mobile device of a user.
Aspect 12. The intelligent risk detection system of Aspect 11, wherein the risk mitigation activation sensor transmits the command to the application associated with the smart mobile device of the user to automatically at least one of: unlock doors associated with a building associated with the user and communicatively coupled to the smart mobile device, disable an electronic component communicatively coupled to the smart mobile device, shut off a water valve or a gas valve communicatively coupled to the smart mobile device when a respective water or gas leak is detected, close a garage door communicatively coupled to the smart mobile device when the user is not detected within a boundary of the building including the garage door, activate lighting of the building and communicatively coupled to the smart mobile device to illuminate a path for the user to escape the building, or activate a sprinkler or fire extinguishing system communicatively coupled to the smart mobile device to contain or put out a fire.
Aspect 13. The intelligent risk detection system of any of Aspect 1 to Aspect 12, wherein the one or more risk factors based on the one or more sensors include a monitored activity associated with the monitored item above a monitored activity threshold, a proximity of a user with respect to the monitored item, or combinations thereof.
Aspect 14. The intelligent risk detection system of Aspect 13, wherein the one or more risk factors are further based on a risk profile of the user stored in a user risk profile database, the user risk profile database communicatively coupled to the intelligent risk detection system.
Aspect 15. The intelligent risk detection system of Aspect 13 or Aspect 14, wherein the one or more risk factors further include external data including an indication of weather data in a proximity to the monitored item, wherein the indication of weather data at a first level is configured to decrease the threshold risk score, the indication of weather data at a second level above the first level is configured to maintain the threshold risk score, and the indication of weather data at a third level above the second level is configured to increase the threshold risk score.
Aspect 16. The intelligent risk detection system of any of Aspect 1 to Aspect 15, further including a pricing model configured to at least one of set or dynamically adjust an insurance premium pricing for a user associated with the monitored item based on a plurality of historical risk scores for a plurality of users over a period of time, a plurality of risk factors for the plurality of users of the period of time, or combinations thereof.
Aspect 17. The intelligent risk detection system of any of Aspect 1 to Aspect 16, further including a pricing model configured to adjust an insurance premium pricing for a user based on the risk score for the user over a period of time, wherein the pricing model is configured to lower the insurance premium pricing when the risk score decreases over the period of time to below a first risk score level, maintain the insurance premium pricing when the risk score stays over the period of time at a second risk score level above the first risk score level, and raise the insurance premium pricing when the risk score increases over the period of time to a third risk score level above the second risk score level, wherein the third risk score level is above the threshold risk score.
Aspect 18. The intelligent risk detection system of any of Aspect 1 to Aspect 17, wherein the machine readable instructions further cause the intelligent risk detection system to perform at least the following when executed by the one or more processors: adjust the risk score associated with the user based on the one or more risk factors including one or more risk factor points based on a single detection event, a series of aggregated detection events, one or more event detection patterns, an absence of risky events, user response to the risk detection alert, or combinations thereof, wherein: the risk score is lowered in response to the one or more risk factor points being below a first risk factor threshold, the risk score is maintained in response to the one or more risk factor points being below a second risk factor threshold above the first risk factor threshold, and the risk score is increased in response to the one or more risk factor points being above a third risk factor threshold above the second risk factor threshold.
Aspect 19. An intelligent risk detection system including: one or more processors, one or more memory components communicatively coupled to the one or more processors, and machine readable instructions stored in the one or more memory components that cause the intelligent risk detection system to perform at least the following when executed by the one or more processors: determine one or more risk factors with respect to a monitored item based on one or more sensors. The one or more sensors may include (i) one or more risk detection sensors configured to monitor the monitored item, (ii) one or more user detection sensors configured to detect a location of the user, (iii) or combinations thereof. The one or more risk factors based on the one or more sensors may include (i) a monitored activity associated with the monitored item above a monitored activity threshold, (ii) a proximity of a user with respect to the monitored item, or (iii) combinations thereof, The machine readable instructions may further cause the intelligent risk detection system to perform at least the following when executed by the one or more processors: determine, via a risk model, a risk score indicative of a risk of a danger event based on the one or more risk factors, detect whether the risk score indicative of the risk of the danger event is above a threshold risk score, generate a risk event detection when the risk score indicative of the risk of the danger event is above the threshold risk score, transmit a risk detection alert based on generation of the risk event detection, activate a risk mitigation activation sensor based on the risk detection alert, and determine, via the risk model and based on the one or more risk factors, whether an updated risk score indicative of the risk of the danger event is below the threshold risk score such that the risk of the danger event is determined to be mitigated.
Aspect 20. A method for intelligent risk detection, the method including: determining one or more risk factors with respect to a monitored item based on one or more sensors, determining, via a risk model, a risk score indicative of a risk of a danger event based on the one or more risk factors, detecting whether the risk score indicative of the risk of the danger event is above a threshold risk score, generating a risk event detection when the risk score indicative of the risk of the danger event is above the threshold risk score, transmitting a risk detection alert based on generation of the risk event detection, activating a risk mitigation activation sensor based on the risk detection alert, and determining, via the risk model and based on the one or more risk factors, whether an updated risk score indicative of the risk of the danger event is below the threshold risk score such that the risk of the danger event is determined to be mitigated.

1. An intelligent risk detection system, the intelligent risk detection system comprising:
one or more processors;
one or more memory components communicatively coupled to the one or more processors; and
machine readable instructions stored in the one or more memory components that cause the intelligent risk detection system to perform at least the following when executed by the one or more processors:
determine one or more risk factors with respect to a monitored item based on one or more sensors;
determine, via a risk model, a risk score indicative of a risk of a danger event based on the one or more risk factors;
detect whether the risk score indicative of the risk of the danger event is above a threshold risk score;
generate a risk event detection when the risk score indicative of the risk of the danger event is above the threshold risk score;
transmit a risk detection alert based on generation of the risk event detection;
activate a risk mitigation activation sensor based on the risk detection alert; and
determine, via the risk model and based on the one or more risk factors, whether an updated risk score indicative of the risk of the danger event is below the threshold risk score such that the risk of the danger event is determined to be mitigated.

2. The intelligent risk detection system of claim 1, wherein the one or more sensors comprise one or more risk detection sensors configured to monitor the monitored item, one or more user detection sensors configured to detect a location of a user, or combinations thereof.

3. The intelligent risk detection system of claim 2, wherein the one or more risk detection sensors are configured to monitor the monitored item via an audiovisual signal, a thermal signal, a sound signal, or combinations thereof, wherein the one or more user detections sensors are configured to detect the location of the user in a room with respect to a distance of the item being monitored via location sensing of the user, audiovisual sensing of the user, sound sensing of the user, or combinations thereof.

4. The intelligent risk detection system of claim 1, wherein the machine readable instructions further cause the intelligent risk detection system to perform at least the following when executed by the one or more processors:
detect, via the risk model and based on the one or more risk factors, whether the risk score is indicative of:
a normal level of risk associated with the monitored item below a normal threshold risk score, wherein the normal threshold risk score is below the threshold risk score;
a medium level of risk associated with the monitored item above the normal threshold risk score and below a medium threshold risk score, wherein the medium threshold risk score is greater than the normal threshold risk score and one of below or above the threshold risk score; or
a high level of risk associated with the monitored item above the medium threshold risk score and below a high threshold risk score, wherein the high threshold risk score is greater than the medium threshold risk score and above the threshold risk score.

5. The intelligent risk detection system of claim 4, wherein the machine readable instructions further cause the intelligent risk detection system to perform at least the following when executed by the one or more processors:
detect, via the risk model, the risk score is indicative of the normal level of risk when a detected heat of the monitored item is determined to be within a first predetermined heat range associated with a normal range for cooking, within a boundary of the monitored item within a suitable predefined tolerance, or combinations thereof;
detect, via the risk model, the risk score is indicative of the medium level of risk when the detected heat of the monitored item is determined to be within a second predetermined heat range higher than the first predetermined heat range, outside the boundary of the monitored item within a first boundary range outside of the suitable predefined tolerance, or combinations thereof; and
detect, via the risk model, the risk score is indicative of the high level of risk when the detected heat of the monitored item is determined to be within a third predetermined heat range higher than the second predetermined heat range, outside the boundary of the monitored item within a second boundary range outside of the suitable predefined tolerance and greater than the first boundary range, or combinations thereof.

6. The intelligent risk detection system of claim 5, wherein the machine readable instructions further cause the intelligent risk detection system to perform at least the following when executed by the one or more processors:
activate the risk mitigation activation sensor to automatically transmit the risk detection alert when the one or more sensors sense the detected heat of the monitored item is outside of the boundary of the monitored item within the first boundary range or the second boundary range.

7. The intelligent risk detection system of claim 6, wherein the risk detection alert is transmitted to a fire department system, a smart mobile device of a first user in a first building in which the monitored item is contained, a smart mobile device of a second user in another building in a predefined proximity to the first building, or combinations thereof.

8. The intelligent risk detection system of claim 6, wherein the monitored item comprises a container on a stovetop, the risk detection alert when the one or more sensors sense the detected heat of the monitored item is outside of the boundary of the monitored item within the first boundary range or the second boundary range is indicative of a fire spread beyond the container, and the risk detection alert comprises educational material related to mitigation of the risk of the danger event.

9. The intelligent risk detection system of claim 1, wherein the monitored item comprises a container on a stovetop, a portable space heater, an oven, a candle, a water heater, a dryer vent, fluid containing item to prevent fluid leaks, gas containing item monitored to prevent gas leaks, or combinations thereof.

10. The intelligent risk detection system of claim 1, wherein the risk detection alert comprises educational material comprising instructions, coaching, or combinations thereof related to mitigation of the danger event.

11. The intelligent risk detection system of claim 1, wherein the machine readable instructions further cause the intelligent risk detection system to perform at least the following when executed by the one or more processors:
activate the risk mitigation activation sensor when the risk of the danger event is above the threshold risk score and after a predetermined period of time, wherein the risk mitigation activation sensor transmits a command to an application associated with a smart mobile device of a user.

12. The intelligent risk detection system of claim 11, wherein the risk mitigation activation sensor transmits the command to the application associated with the smart mobile device of the user to automatically at least one of:
unlock doors associated with a building associated with the user and communicatively coupled to the smart mobile device;
disable an electronic component communicatively coupled to the smart mobile device;
shut off a water valve or a gas valve communicatively coupled to the smart mobile device when a respective water or gas leak is detected;
close a garage door communicatively coupled to the smart mobile device when the user is not detected within a boundary of the building comprising the garage door;
activate lighting of the building and communicatively coupled to the smart mobile device to illuminate a path for the user to escape the building; or
activate a sprinkler or fire extinguishing system communicatively coupled to the smart mobile device to contain or put out a fire.

13. The intelligent risk detection system of claim 1, wherein the one or more risk factors based on the one or more sensors comprise a monitored activity associated with the monitored item above a monitored activity threshold, a proximity of a user with respect to the monitored item, or combinations thereof.

14. The intelligent risk detection system of claim 13, wherein the one or more risk factors are further based on a risk profile of the user stored in a user risk profile database, the user risk profile database communicatively coupled to the intelligent risk detection system.

15. The intelligent risk detection system of claim 13, wherein the one or more risk factors further comprise external data comprising an indication of weather data in a proximity to the monitored item, wherein the indication of weather data at a first level is configured to decrease the threshold risk score, the indication of weather data at a second level above the first level is configured to maintain the threshold risk score, and the indication of weather data at a third level above the second level is configured to increase the threshold risk score.

16. The intelligent risk detection system of claim 1, further comprising a pricing model configured to at least one of set or dynamically adjust an insurance premium pricing for a user associated with the monitored item based on a plurality of historical risk scores for a plurality of users over a period of time, a plurality of risk factors for the plurality of users of the period of time, or combinations thereof.

17. The intelligent risk detection system of claim 1, further comprising a pricing model configured to adjust an insurance premium pricing for a user based on the risk score for the user over a period of time, wherein the pricing model is configured to lower the insurance premium pricing when the risk score decreases over the period of time to below a first risk score level, maintain the insurance premium pricing when the risk score stays over the period of time at a second risk score level above the first risk score level, and raise the insurance premium pricing when the risk score increases over the period of time to a third risk score level above the second risk score level, wherein the third risk score level is above the threshold risk score.

18. The intelligent risk detection system of claim 1, wherein the machine readable instructions further cause the intelligent risk detection system to perform at least the following when executed by the one or more processors:
adjust the risk score associated with a user based on the one or more risk factors comprising one or more risk factor points based on a single detection event, a series of aggregated detection events, one or more event detection patterns, an absence of risky events, user response to the risk detection alert, or combinations thereof, wherein:
the risk score is lowered in response to the one or more risk factor points being below a first risk factor threshold,
the risk score is maintained in response to the one or more risk factor points being below a second risk factor threshold above the first risk factor threshold, and
the risk score is increased in response to the one or more risk factor points being above a third risk factor threshold above the second risk factor threshold.

19. An intelligent risk detection system comprising:
one or more processors;
one or more memory components communicatively coupled to the one or more processors; and
machine readable instructions stored in the one or more memory components that cause the intelligent risk detection system to perform at least the following when executed by the one or more processors:
determine one or more risk factors with respect to a monitored item based on one or more sensors, wherein the one or more sensors comprise one or more risk detection sensors configured to monitor the monitored item, one or more user detection sensors configured to detect a location of a user, or combinations thereof, and wherein the one or more risk factors based on the one or more sensors comprise a monitored activity associated with the monitored item above a monitored activity threshold, a proximity of the user with respect to the monitored item, or combinations thereof;
determine, via a risk model, a risk score indicative of a risk of a danger event based on the one or more risk factors;
detect whether the risk score indicative of the risk of the danger event is above a threshold risk score;
generate a risk event detection when the risk score indicative of the risk of the danger event is above the threshold risk score;
transmit a risk detection alert based on generation of the risk event detection;
activate a risk mitigation activation sensor based on the risk detection alert; and
determine, via the risk model and based on the one or more risk factors, whether an updated risk score indicative of the risk of the danger event is below the threshold risk score such that the risk of the danger event is determined to be mitigated.

20. A method for intelligent risk detection, the method comprising:
determining one or more risk factors with respect to a monitored item based on one or more sensors;
determining, via a risk model, a risk score indicative of a risk of a danger event based on the one or more risk factors;
detecting whether the risk score indicative of the risk of the danger event is above a threshold risk score;
generating a risk event detection when the risk score indicative of the risk of the danger event is above the threshold risk score;
transmitting a risk detection alert based on generation of the risk event detection;
activating a risk mitigation activation sensor based on the risk detection alert; and
determining, via the risk model and based on the one or more risk factors, whether an updated risk score indicative of the risk of the danger event is below the threshold risk score such that the risk of the danger event is determined to be mitigated.
